(19) United States
(12) Patent Application Publication
(10) Pub. No.: US 2005/0095121 A1
(43) Pub. Date: May 5, 2005

(54) Unitary fan-motor grill assembly

(76) Inventor: Anand Vithani, Addison, IL (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/887,735

(22) Filed: Jul. 9, 2004

Related U.S. Application Data
(60) Provisional application No. 60/517,499, filed on Nov. 5, 2003.

(51) Int. Cl. F03B 11/08

(52) U.S. Cl. 415/121.2

(57) ABSTRACT

A unitary fan-motor grill assembly that integrates a fan-motor subassembly within a grill assembly and a fan-motor housing is disclosed. The fan-motor housing is configured to receive a fan-motor subassembly and includes motor latches and posts for fixing the fan-motor subassembly in place. The grill assembly is provided with housing latches to secure it in place in front of the fan blade of the fan-motor subassembly by attaching to the fan-motor housing. The fan-motor housing includes mounting latches for fixing the integrated fan-motor grill assembly in place on an evaporator housing or similar receptacle. The unitary fan-motor grill assembly may be installed or removed in a single step without requiring the use of non-integral fasteners.

### CROSS REFERENCE

This application claims priority to U.S. Provisional Application Ser. No. 60/517,499, titled “Unitary Fan-Motor Grill Assembly”, filed on Nov. 5, 2003.

### FIELD OF THE INVENTION

The present invention relates to a unitary fan-motor grill assembly. More particularly, the present invention relates to a unitary fan-motor grill assembly that can be affixed to an opening on a refrigeration unit in a single step without the use of fasteners.

### BACKGROUND OF THE INVENTION

Automatic defrost ice merchandisers used today include evaporator units, usually located on the ceiling of the ice merchandiser. The evaporator units will typically have one to three fan-motor subassemblies (including a fan motor and a fan blade), depending on the size of the ice merchandiser. The fan-motor subassemblies circulate cold air to assure total air convection flow around the ice product, and aid in the defrost process. A grill assembly is included to provide a protective screen for the fan blade; thus, the fan-motor subassembly is located behind the grill assembly. Fan-motors see extended use and frequent on/off operation that may burn out the coil of the motor or wear out the bearings, requiring them to be replaced.

Fan-motor grill assemblies are typically plastic, and are fastened to an opening on the evaporator-housing. The fan of the fan-motor subassembly is generally secured to the motor of the fan-motor assembly using a metal bracket or strap. The fan-motor subassembly is secured to the side of the evaporator housing opposite the grill assembly using fasteners installed through a flange formed in the strap. Threaded fasteners are used to secure components and assemblies together throughout. Thus, the prior art fan-motor grill assemblies are installed from two sides of the evaporator housing opening; the grill assembly is fastened to the front of the evaporator housing opening while the fan-motor subassembly and strap are assembled to the rear of the evaporator housing opening. Installation in this fashion is difficult to accomplish, as the evaporator housing blocks an installer's view of the parts being installed on the opposite side. The need to use fasteners further complicates installation, as fasteners must be aligned with holes, sometimes under conditions where a good view of the holes is unavailable.

FIG. 1 illustrates the components of a fan-motor grill assembly of the prior art. As shown in the Figure, a fan-motor assembly of the prior art generally includes a plastic grill 10, fan blades 12, a fan motor 14, a metal strap 16, and several fasteners 18. These components are assembled as described above. Prior art fan-motor grill assemblies possess numerous disadvantages. Fan-motor grill assemblies of this type include numerous components, that by their nature must be fabricated using multiple manufacturing processes. For example, the grill is molded, the straps are stamped and formed, and the fasteners are prepared by turning on a screw-machine. Typically, different suppliers must be used to provide these components, resulting in increased logistic and paperwork costs.

Another disadvantage of the prior art fan-motor grill assembly is that installation of the fan is difficult and time consuming. This is a result of various factors. First, the time required to assemble the strap, fan-motor subassembly and mount the fan-motor subassembly and grill to the air duct is substantial. Second, the washers and screws used as fasteners to assemble the strap and fan-motor are generally small and difficult to handle. Installation of the fan-motor subassembly, the strap, and the grill into the evaporator housing is awkward, requiring the simultaneous handling of the parts, fasteners, and fastener screwdrivers. The difficulty is further exacerbated during field service when complete assembly of the evaporator housing makes the air duct further inaccessible. The ice merchandiser may also be filled with product, obstructing access to the fan-motor grill assembly. As a result of the difficulties involved in installation, it is not unusual for fasteners to be inadvertently dropped into the merchandiser. Dropping a fastener in an ice merchandiser during installation in the field may result in the fastener becoming commingled with the product, making retrieval extremely difficult.

There is therefore a need for a fan-motor and grill assembly with a different design that can be manufactured and installed more inexpensively and efficiently.

### SUMMARY OF THE INVENTION

The present invention provides a unitary fan-motor grill assembly that can be readily manufactured and installed. The unitary fan-motor grill assembly is particularly useful for installation in refrigeration units such as ice merchandisers. More specifically, the invention relates to a fan-motor grill assembly useful for circulating cold air to assure total air convection flow around the product in the merchandiser and/or aid in defrosting. The invention further relates to the mounting of the unitary fan-motor grill assembly to an evaporator housing to form a readily-serviced evaporator housing. The unitary fan-motor grill assembly of the present invention includes a fan-motor housing designed to receive a fan-motor subassembly, the fan-motor housing including fan-motor engaging latches for fixing the fan-motor subassembly in place. The fan-motor housing also includes mounting latches for affixing the unitary fan-motor grill assembly to an opening such as the opening in an evaporator housing. The fan-motor housing encloses the fan-motor subassembly, and the fan-motor grill assembly attaches to the evaporator housing, both without requiring the use of fasteners.

The unitary fan-motor grill assembly combines the grill, strap, and fasteners of the prior art into a single device. The unitary fan-motor grill assembly provides a grill and fan-motor housing which snaps into place on the evaporator housing opening. The term unitary is used to represent that fact that a single device can be placed and attached within an opening, rather than having to use multiple components such as a separate grill, housing, and fasteners. More specifically, the fan-motor grill assembly includes a grill assembly, a fan-motor housing for receiving a fan-motor subassembly, and mounting latches. The unitary fan-motor grill assembly includes various attachment devices that retain the fan-motor subassembly within the housing, attach the grill to the housing, and retain the unitary fan-motor grill assembly within an opening. A refrigeration unit equipped with the unitary fan-motor grill assembly is readily-serviced due to the ease with which the unitary fan-motor grill assembly can be installed and removed.

By integrating several features into a unitary design, the cost and complexity associated with the preparation and use of various separate parts are eliminated. The prior art requires installation of the fan-motor subassembly and strap from the rear of the evaporator housing and installation of the grill from the front of the evaporator housing. The fan-motor grill assembly of the present invention, on the other hand, may be installed solely from one side of the evaporator housing, and thus does not require that work be done from both sides. The prior art requires fasteners at the point where the fan-motor subassembly attaches to the strap and at the point where the fan-motor subassembly and strap install on the evaporator housing. Fasteners are also used in the prior art to attach the grill to the evaporator housing. None of these fasteners are required for construction or installation of the fan-motor grill assembly of the present invention.

By providing a unitary fan-motor grill assembly that does not require fasteners or other parts for assembly and/or installation, the cost and complexity of manufacturing and installing the fan-motor grill assembly is reduced. Further, by allowing installation to be accomplished from a single side of the evaporator housing, the need for difficult out-of-sight manipulation of fasteners is eliminated.

### BRIEF DESCRIPTION OF THE DRAWINGS

The following figures illustrate various aspects of one embodiment of the present invention, but are not intended to limit the present invention to the embodiment shown.

FIG. 1 is a view of a grill and fan-motor subassembly with fasteners of the prior art.

FIG. 2 is an exploded view of a unitary fan-motor grill assembly.

FIG. 3 is a top perspective view of a grill assembly.

FIG. 4 is a bottom perspective view of a grill assembly.

FIG. 5 is a top perspective view of a fan motor housing.

FIG. 6 is a bottom perspective view of a fan motor housing.

FIG. 7 is a bottom perspective view of a unitary fan-motor grill assembly ready for use.

FIG. 8 is a top perspective view of a fan-motor grill assembly secured to an evaporator housing.

### DETAILED DESCRIPTION

The following discussion is presented to enable a person skilled in the art to make and use the invention. Various modifications will be readily apparent to those skilled in the art, and the general principles disclosed herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein. In particular, while the present invention is described primarily for mounting to the evaporator housing of an automatic defrost ice merchandiser, the invention may be utilized for positioning a fan on a variety of other devices as well. The following detailed description is to be read with reference to the figures, in which like elements in different figures have like reference numerals. The figures, which are not necessarily to scale, depict selected embodiments and are not intended to limit the scope of the invention. Skilled artisans will recognize the embodiments provided herein have many useful alternatives that fall within the scope of the invention.

The present invention provides a unitary fan-motor grill assembly that can be readily manufactured and installed. The unitary fan-motor grill assembly is particularly useful for installation in refrigeration units. For example, the unitary fan-motor grill assembly may be installed in the evaporator units of refrigeration units such as ice merchandisers. More specifically, the invention relates to a unitary fan-motor grill assembly that circulates cold air to assure total air convection flow around the ice product in an automatic defrost ice merchandiser. The evaporator housing is the device within the refrigerator in which refrigerant in the refrigerator coils evaporates, causing heat to be withdrawn from the evaporator housing, thereby forming colder air. The colder air is preferably circulated within the refrigeration unit by an evaporator fan, such as that provided by an installed unitary fan-motor grill assembly of the present invention. The invention further relates to the mounting of the unitary fan-motor grill assembly to an opening such as that on an evaporator housing. The invention provides a fan-motor housing for receiving a fan-motor subassembly, the entire fan-motor grill assembly being configured for snapping into place on an evaporator housing.

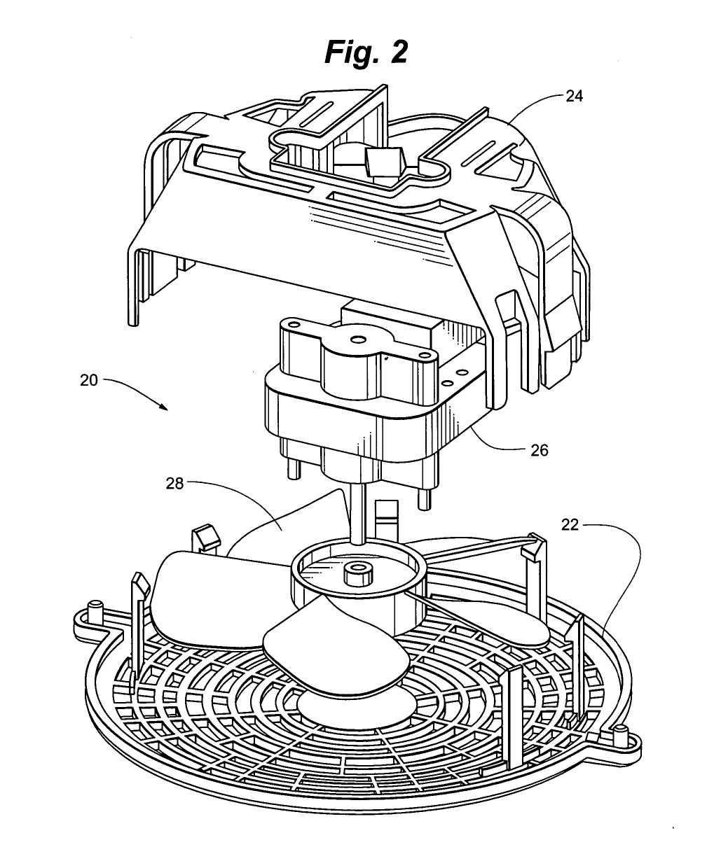

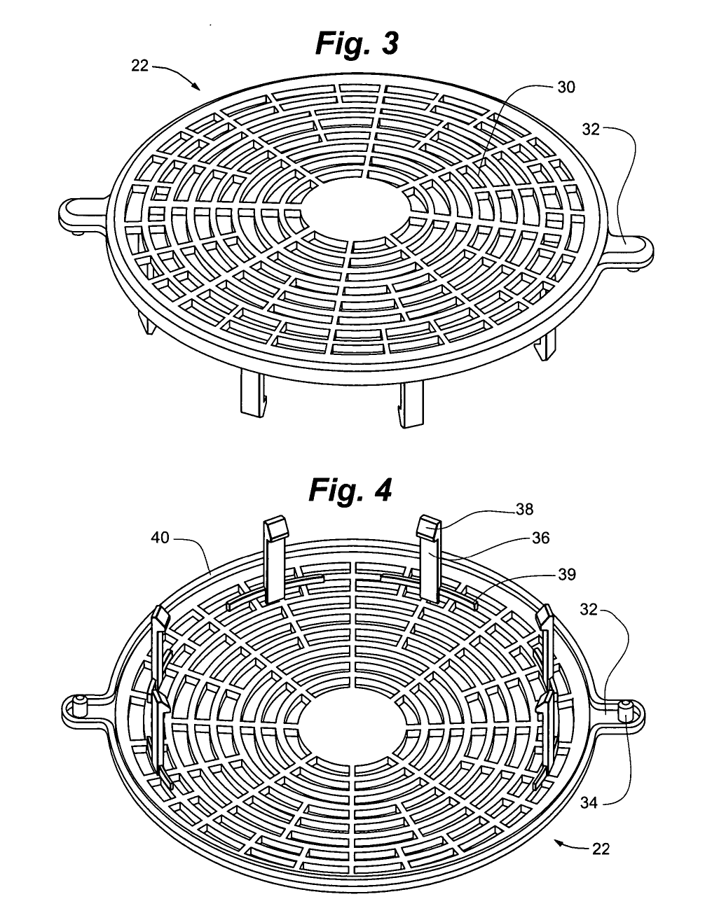

FIG. 2 is an exploded view of a fan-motor grill assembly 20 and a fan-motor subassembly 26 bearing a fan blade 28 in accordance with one embodiment of the present invention. As shown in the figure, the fan-motor grill assembly 20 includes four components: the grill assembly 22, the fan-motor housing 24, the fan-motor subassembly 26, and the fan blade 28. Generally, the fan-motor housing 24 secures the fan-motor subassembly 26 behind the grill assembly 22 such that the fan blade 28, which is connected to and driven by the fan-motor subassembly 26, is positioned adjacent to but preferably not touching the grill assembly 22. The fan blade 28 is connected to the fan-motor subassembly 26 by the fan motor shaft. The fan-motor subassembly 26 is a generally a conventional electromagnetic fan motor that includes bearings, mounting lugs, a fan shaft, and electromagnetic coils (not specifically shown). However, other fan-motors may be used and are contemplated within the scope of the present invention. The fan blade 28 fitted to the shaft is generally made from a flexible plastic, and the blade pitched slightly to pull or push air when it rotates. The unitary fan-motor grill assembly 20 comprising these four components is configured to snap into place in an aperture on a surface such as an evaporator housing 56. The grill assembly 22 and the fan-motor housing 24 are described in greater detail in FIGS. 3-6, below.

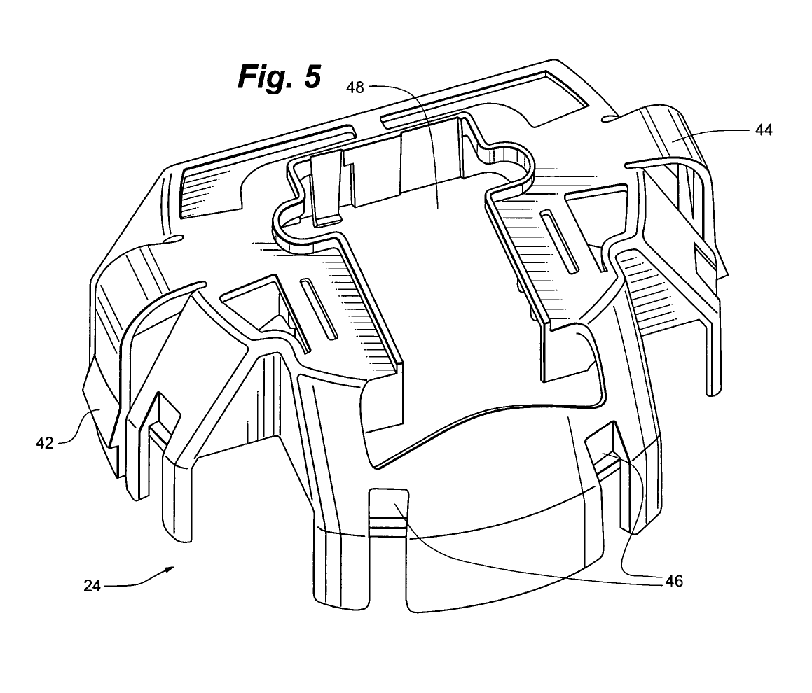

FIG. 3 provides a top perspective view of one embodiment of a grill assembly 22. The grill assembly 22 is a generally grate with a flat, open, patterned framework 30 (e.g., a lattice structure) that allows air to pass while serving as a screen to prevent intrusion of larger foreign objects into the fan-motor grill assembly. The grill assembly is preferably also sufficiently durable to resist at least moderately forceful impact by exterior objects. The grill assembly 22 preferably has a shape that matches the opening to which it is intended to be fitted. For example, the grill assembly 22 shown in the figures has a circular shape that will match circular openings. The grill assembly 22 itself preferably includes one or more mounting lobes 32 that extend beyond the circumference of the grill assembly 22. Each mounting lobe 32 bears a locating pin 34 that extends downwards towards the fan-motor housing 24. The locating pins 34 are more readily seen in FIG. 4, which provides a bottom perspective view of a grill assembly 22. The bottom of the grill assembly 22 also bears one or more housing latches 36. The housing latches 36 are preferably rectangular members with a retaining barb 38 positioned such that they snap to and secure the fan-motor housing 24. The housing latches 36 preferably have sufficient elasticity to allow the retaining barbs 38 to be displaced but then snap into place when in their final position. Preferably, the housing latches are mounted on support members 39 that reinforce attachment of the housing latches 36 to the grill assembly 22 and serve to support the fan-motor housing 24 when it is attached to the grill assembly 22. The grill assembly 22 should be configured to fit snugly over an opening in an evaporator housing such that air directed through the opening passes through the grill assembly 22 and vibration between the grill assembly 22 and the evaporator housing is minimized.

As shown in FIG. 4, a grill flange 40 may be provided to further secure the fan-motor grill assembly 20 to the evaporator housing. If present, the grill flange 40 is provided along the outer edge of the grill assembly 22. The grill flange 40 may be curved such that as it mates to the evaporator housing opening, the curved surface flexes, thereby resisting the force being applied to insert the assembly 20. This tension further prevents rattles, noise, and vibration which could otherwise result from the looseness caused by part fit clearances. The locating pins 34 aid in alignment of the fan-motor grill assembly 20 with attachment holes in the evaporator housing. The fan-motor grill assembly 20 of the present invention installs from a single side of the evaporator housing 56.

The fan-motor housing 24 and the grill assembly 22 of the fan-motor grill assembly 20 are configured to provide a single straight-pull part to facilitate manufacture. Mold core pins are part of the mold used to manufacture the fan-motor grill assembly 20. While the mold core pins remain with the mold and are not part of the eventual fan-motor grill assembly 20, they are important in enabling the fan-motor housing 24 and the grill assembly 22 of the fan-motor grill assembly 20 to be molded as single, unitary pieces. The technique of injection molding is known by those skilled in the art, and can be utilized to mold most polymers, including thermoplastics, fiber reinforced thermoplastics, thermosetting plastics, and elastomers. In particular, injection molding may be utilized to manufacture a unitary fan-motor grill assembly 20 from polycarbonate, acrylic, polyurethane, or polyester polymers.

FIG. 5 provides a top perspective view of one embodiment of a fan-motor housing 24. The fan-motor housing 24 is connected to the grill assembly 22 and serves to hold and position a fan-motor subassembly 26 in place near the grill assembly 22 so that air blown by the fan blade 28 flows in the desired direction. The fan-motor housing 24 is preferably provided with mounting latches 42 that engage the edge of the evaporator-housing opening when the fan-motor grill assembly is inserted. Preferably, the mounting latches 42 are snap-fit latches, as shown, that can be snapped into place to secure the fan-motor grill assembly 20 within the evaporator housing opening. Various other integral latching devices may be provided to fasten the fan-motor grill assembly 20 to the evaporator housing 56, so long as they securely attach the fan-motor grill assembly 20 to the housing without requiring the use of non-integral fasteners. The mounting latches 42 preferably have a wedge shape with a triangular cross-section. Insertion of the fan-motor grill assembly 20 causes the edge of the opening to pass along the wedge of the mounting latch 42, allowing the mounting latch 42 to advance into the evaporating housing opening. However, once the edge of the opening passes the mounting latch 42, it is locked in place. The mounting latch 42 is preferably positioned on a retaining arm 44 that allows the mounting latch 42 to move during insertion, and later allow the mounting latches 42 to be pressed inward to allow the fan-motor grill assembly to disengage when desired.

In addition to being configured to retain the fan-motor housing 24 within the evaporator housing, the fan-motor housing 24 is also configured to hold and position a fan-motor subassembly 26 in place near the grill assembly 22. This involves holding the fan-motor subassembly 26, and attaching the fan-motor housing 24 to the grill assembly 22. Various means of accomplishing these two functions are contemplated within the scope of the present invention. As shown in FIG. 5, the fan-motor housing 24 is provided with several cut-out portions containing a shelf that serve as latch docks 46. The latch docks 46 provide space for the housing latches 36, while the shelf within the latch dock 46 supports the retaining barb 38, tightly holding the fan-motor housing 24 to the grill assembly 22. The fan-motor housing 24 also preferably includes an motor aperture 48 configured to fit the fan-motor subassembly 26. While a motor aperture 48 is not necessary, use of such an aperture, as well as other apertures within the surface of the fan-motor housing 24, reduce the use of material to form the housing and provide for greater ventilation of the fan-motor subassembly 26.

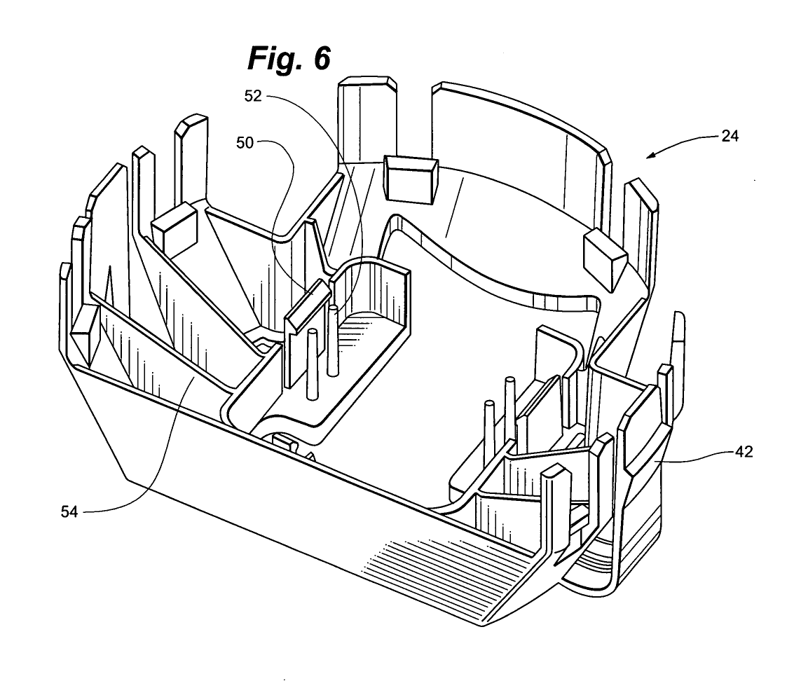

While the motor aperture 48 accommodates the fan-motor subassembly 36, motor latches 50 are preferably included within the fan-motor housing 24 to secure the fan-motor subassembly 26 in place. The motor latches 50 are visible in FIG. 6, which shows a bottom perspective view of an embodiment of the fan motor housing 24. The motor latches 50 are similar to the housing latches 36 as they are generally rectangular members with a retaining barb positioned at the end that allow the fan-motor subassembly 26 to snap in place and be held in position. The motor latches 50 should be dimensioned to fit around a portion of the fan-motor subassembly 26. While a single motor latch 50 will help retain the fan-motor subassembly 26, it is preferable to have two or more motor latches 50 in apposition to better secure the fan-motor subassembly 26 within the fan-motor housing 24. As shown in FIG. 6, posts 52 may also be included to help position the fan-motor subassembly 26. When posts 52 are provided, the fan-motor subassembly 26 is provided with holes with a diameter and positioning that allows the posts 52 to enter the holes and help position and secure the fan-motor subassembly 26. Preferably, the posts 52 are made of material that allows the ends of the posts 52 to be melted and reformed into rivet that helps retain the fan-motor subassembly 26 in place.

The fan-motor housing 24, as shown in FIG. 6, may be provided with rib-like reinforcing struts 54 to strengthen the fan-motor housing 24 and increase its resistance to damage. The fan-motor housing 24 of the present invention may be injection molded and may be formed of plastic or any other material suited for injection molding as described above for the grill assembly 22. Other materials such as metal may be used if it is preferred to not use injection molding in the manufacture of the fan-motor grill assembly 20.

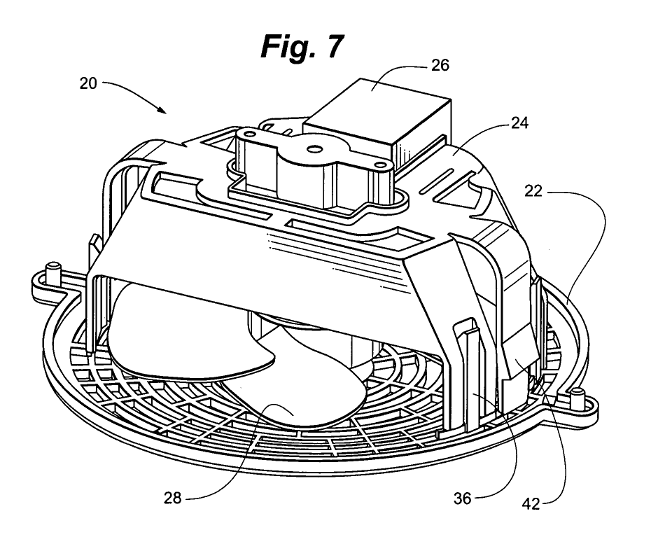

FIG. 7 shows a bottom perspective view of a unitary fan-motor grill assembly 20 that includes a fan-motor subassembly 26 provided with a fan blade 28, mounted between the fan-motor housing 24 and the grill assembly 22. This figure illustrates the appearance of the assembled, unitary assembly, and in particular how the housing latches 36 fit into the latch docks 46 to connect the grill assembly 22 with the fan-motor housing 24. The assembled fan-motor grill assembly 20 is relatively compact and can easily be attached to an aperture where it is retained in place by the mounting latches 42.

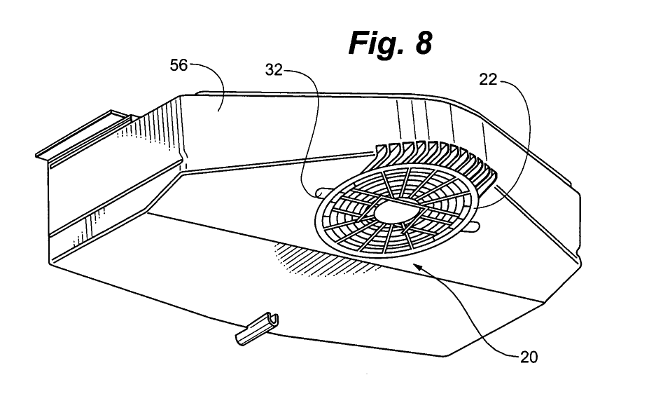

FIG. 8 illustrates an embodiment of the fan-motor grill assembly 20 secured to an evaporator housing 56. The evaporator housing 56 positions the fan-motor grill assembly 20 to allow the fan-motor subassembly 26 to circulate cold air to assure total air convection flow around the ice product. By integrating several features into a unitary design, the cost and complexity associated with the installation of the fan-motor grill assembly 20 into a housing such as an evaporator housing 56 is substantially reduced. Specifically, the fan-motor grill assembly 20 of the present invention may be readily installed from the front of the evaporator housing while reducing the number of steps involved in installation from about five (in the prior art) to one single step; namely, snapping the fan-motor grill assembly 20 into place in the housing. As noted earlier, the fan-motor grill assembly 20 fits into an appropriately shaped opening on the housing, and is retained in place primarily through the action of the mounting latches 42 that snap-fit within the edge of the housing opening.

The fan-motor grill assembly 20 of the present invention may also be readily removed. For field serviceability or factory rework, slots in the face of the grill assembly 22 allow work to be done through the face of the grill assembly 22. Generally, a probe, such as a screwdriver, is inserted to release the mounting latches 42 that secure the fan-motor grill assembly 20 to the evaporator housing 56. By inserting a probe, the mounting latches 42 may be disengaged from the evaporator housing 56 by pressing them inwards, allowing the entire fan-motor grill assembly 20 to be removed from the evaporator housing 56. The present invention further contemplates a fan-motor grill assembly 20 that may be removed by hand; however, there may be regulatory or other considerations that make this undesirable for particular applications. As noted above, the mounting latches 42 are preferably provided on retaining arms 44 that may be bent inwards to disengage the mounting latches 42. The unitary design of the present invention thus allows field rework time to be reduced substantially from about 15 minutes for prior art designs to about 2 minutes for the presently disclosed unitary design.

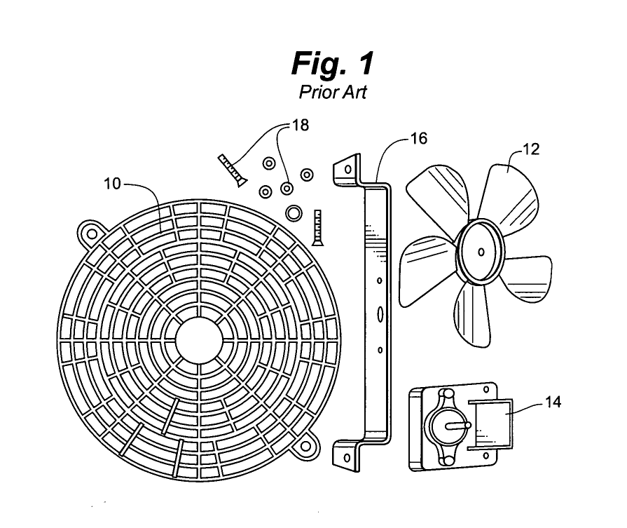

By combining the functions and structures of the prior-art design into a unitary molded part that does not require fasteners to assemble or install, cost and complexity are reduced in manufacturing and in field service. Specifically, the component count is reduced from about ten in the prior art (as shown in FIG. 1), to one (the unitary fan motor assembly). Reducing the number of components simplifies assembly of the device from about seven steps in the prior art down to the single step of snapping the grill assembly 22 into place. Furthermore, by facilitating installation from one side of the evaporator housing, out-of-sight manipulation of fasteners required by the prior art is eliminated. In addition, by using ratcheting latches and curved grill geometry, tolerances generally provided by screw assembly are eliminated without the cost and time needed to apply fasteners.

While various embodiments in accordance with the present invention have been shown and described, it is understood the invention is not limited thereto, and is susceptible to numerous changes and modifications as known to those skilled in the art. Therefore, this invention is not limited to the details shown and described herein, and includes all such changes and modifications as encompassed by the scope of the appended claims.

1. A unitary fan-motor grill assembly, comprising:
(a) a grill assembly comprising a grate that allows air to pass,
(b) a fan-motor housing attached to the grill assembly, and
(c) a fan-motor subassembly enclosed and positioned between the grill assembly and the fan-motor housing without the use of non-integral fasteners.

2. The unitary fan-motor grill assembly of claim 1, further including mounting latches that secure the unitary fan-motor grill assembly within an opening.

3. The unitary fan-motor grill assembly of claim 2, wherein the mounting latches are positioned on flexible retaining arms.

4. The unitary fan-motor grill assembly of claim 1, wherein the grill assembly includes housing latches that secure the grill assembly to the fan-motor housing.

5. The unitary fan-motor grill assembly of claim 4, wherein the grill assembly further comprises locating pins on mounting lobes that extend beyond the circumference of the grate.

6. The unitary fan-motor grill assembly of claim 1, wherein the fan-motor housing includes motor latches that secure the fan-motor subassembly to the fan-motor housing.

7. The unitary fan-motor grill assembly of claim 1, wherein the fan-motor housing includes posts that fit within holes present on the fan-motor subassembly, wherein the posts may be heat-treated to form rivets that secure the fan-motor subassembly to the fan-motor housing.

8. The unitary fan-motor grill assembly of claim 1, wherein the fan-motor housing and the grill assembly each comprise a single piece of molded plastic.

9. The unitary fan-motor grill assembly of claim 1, wherein the fan-motor subassembly comprises a fan blade and a fan motor.

10. The unitary fan-motor grill assembly of claim 2, wherein the mounting latches are configured to allow the unitary fan-motor grill assembly to be affixed within an opening in a single step.

11. A readily-serviced refrigeration unit comprising a refrigeration unit and a unitary fan-motor grill assembly of claim 1 positioned in an opening on the refrigeration unit to circulate air through the refrigeration unit, wherein the unitary fan-motor assembly further comprises one or more mounting latches that allow the unitary fan-motor assembly to be removed from the opening in a single step.

12. The readily-serviced refrigeration unit of claim 11, further comprising an evaporator housing, wherein the unitary fan-motor grill assembly is positioned in an opening on the evaporator housing.

13. The readily-serviced refrigeration unit of claim 12, wherein the refrigeration unit is an ice merchandiser.

14. A unitary fan-motor housing, comprising:
(a) a grill assembly comprising a grate that allows air to pass,
(b) a fan-motor subassembly comprising a fan blade and a fan motor, and
(c) means for affixing the fan-motor subassembly within an opening in a single step without the use of non-integral fasteners.

15. The unitary fan-motor housing of claim 14, wherein the opening comprises an opening on a refrigerator evaporator housing.

16. A readily-serviced refrigerator evaporator housing, comprising an evaporator housing and a unitary fan-motor grill assembly positioned in an opening on the evaporator housing, wherein the unitary fan-motor grill assembly comprises:
(a) a grill assembly comprising a grate that allows air to pass,
(b) a fan-motor housing attached to the grill assembly, and
(c) a fan-motor subassembly enclosed and positioned between the grill assembly and the fan-motor housing without the use of non-integral fasteners.

17. The readily-serviced refrigerator evaporator housing of claim 16, further including mounting latches that secure the unitary fan-motor grill assembly within the opening on the evaporator housing.

18. The readily-serviced refrigerator evaporator housing of claim 17, wherein the mounting latches are positioned on flexible retaining arms.

19. The readily-serviced refrigerator evaporator housing of claim 16, wherein the fan-motor housing and the grill assembly each comprise a single piece of molded plastic.
